(19) United States
(12) Patent Application Publication
(10) Pub. No.: US 2023/0386690 A1
(43) Pub. Date: Nov. 30, 2023

(54) SILICON ENHANCED IONIZING RADIATION SHIELDING AND ITS METHOD OF MANUFACTURE

(71) Applicant: Stark Street Materials Company, Portland, OR (US)

(72) Inventor: Anna Brown, Portland, OR (US)

(73) Assignee: Stark Street Materials Company, Portland, OR (US)

(21) Appl. No.: 17/752,595

(22) Filed: May 24, 2022

(51) Int. Cl. G21F 1/08; C08K 9/02

(52) U.S. Cl. CPC G21F 1/08; C08K 9/02; C08K 2201/005

(57) ABSTRACT

An article of ionizing radiation shielding and a method of its manufacture are disclosed. In an example, the method of manufacturing the article of ionizing radiation shielding comprises mixing a first particulate of a first material with TEOS or other suitable alkoxides of silicon to obtain a first powder. The first material comprises a metal, semi-metal, metalloid, or oxide of one or more elements having an atomic number of 50 through 83. The method further comprises hydrolyzing the first powder to obtain first particles comprising the first particulate coated with an exterior layer comprising silica and/or silica oxide. The method further comprises reacting the first particles with TEVS or other suitable silane coupling/adhesion promoting agent to obtain first reacted particles. The method further comprises combining the first reacted particles with an uncured silicone solution to obtain a mixture; and curing the mixture into a cured form.

### STATEMENT OF GOVERNMENT LICENSE RIGHTS

This invention was made with government support under contract award number 2025671 awarded by the National Science Foundation. The government has certain rights in the invention.

### BACKGROUND

Ionizing radiation shielding is used in a variety of fields to reduce exposure of ionizing radiation to humans or other organisms, electronic devices, or environments from an ionizing radiation source. Materials such as lead or other dense metals are commonly used as ionizing radiation shielding. However, many of these materials have disadvantages such as toxicity or potential toxicity to humans or other organisms, relatively poor flexibility or bending characteristics, susceptibility to oxidation or other forms of degradation.

### SUMMARY

An article of ionizing radiation shielding and a method of its manufacture are disclosed. According to an example, the method of manufacturing the article of ionizing radiation shielding comprises mixing a first particulate of a first material with tetraethoxysilane (TEOS) and/or other suitable alkoxide(s) of silicon to obtain a first powder. The first material comprises a metal, semi-metal, metalloid, or oxide of one or more elements having an atomic number of 50 through 83, such as Bismuth, as an example. In at least some examples, the first powder can be obtained by grinding solids of the first material in the presence of the TEOS and/or other alkoxide(s) of silicon as part of mixing.

The method further comprises hydrolyzing the first powder to obtain first particles comprising the first particulate coated with an exterior layer comprising silica and/or silica oxide. The method further comprises reacting the first particles with triethoxyvinylsilane (TEVS) or other suitable silane coupling/adhesion promoting agent(s) to obtain first reacted particles having an exterior functional layer composed of organic or inorganic moieties. The method further comprises combining the first reacted particles with an uncured silicone solution to obtain a mixture; and curing the mixture into a cured form. In at least some examples, similarly reacted particles of other materials can be combined to form part of the mixture prior to curing. The cured form can be configured as or further processed into a flexible sheet of ionizing radiation shielding, as an example.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a flow diagram depicting an example method of manufacturing an article of ionizing radiation shielding.

FIG. 2 is a schematic diagram depicting an example implementation of method 100 of FIG. 1.

### DETAILED DESCRIPTION

As briefly summarized above, ionizing radiation shielding is used in a variety of fields to reduce exposure of ionizing radiation to humans or other organisms, electronic devices, or environments from an ionizing radiation source. Materials such as lead or other dense metals are commonly used within ionizing radiation shielding. However, many of these materials have disadvantages such as toxicity or potential toxicity to humans or other organisms, relatively poor flexibility or bending characteristics, susceptibility to oxidation or other forms of degradation.

An article of ionizing radiation shielding and a method of its manufacture are disclosed herein. As an illustrative example, the ionizing radiation shielding can be used to shield humans, animals, or objects from ionizing radiation in the X-ray spectrum range, such as may be used in medical imaging, security screening, and other contexts. However, it will be understood that the ionizing radiation shielding disclosed herein can be configured for use for alternative or additional types of ionizing radiation, including spectrum ranges that include, partially include, or fully exclude the X-ray spectrum range.

According to an example, the method of manufacturing the article of ionizing radiation shielding comprises mixing a first particulate of a first material with tetraethoxysilane (TEOS) and/or other suitable alkoxide(s) of silicon to obtain a first powder. The first material comprises a metal, semi-metal, metalloid, or oxide of one or more elements having an atomic number of 50 through 83, such as Bismuth, as an example. In at least some examples, the first powder can be obtained by grinding solids of the first material in the presence of the TEOS and/or other alkoxide(s) of silicon as part of mixing.

The method further comprises hydrolyzing the first powder to obtain first particles comprising the first particulate coated with an exterior layer comprising silica and/or silica oxide. The method further comprises reacting the first particles with triethoxyvinylsilane (TEVS) or other suitable silane coupling/adhesion promoting agent(s) to obtain first reacted particles having an exterior functional layer. As an example, the exterior functional layer can be comprised of organic or inorganic moieties. The exterior functional layer can improve adhesion or bonding between particulate of ionizing radiation shielding materials and silicone within which such particulate is encapsulated.

The method further comprises combining the first reacted particles with an uncured silicone solution to obtain a mixture; and curing the mixture into a cured form. In at least some examples, similarly reacted particles of other materials can be combined to form part of the mixture prior to curing. The cured form can be configured as or further processed into a flexible sheet of ionizing radiation shielding, as an example.

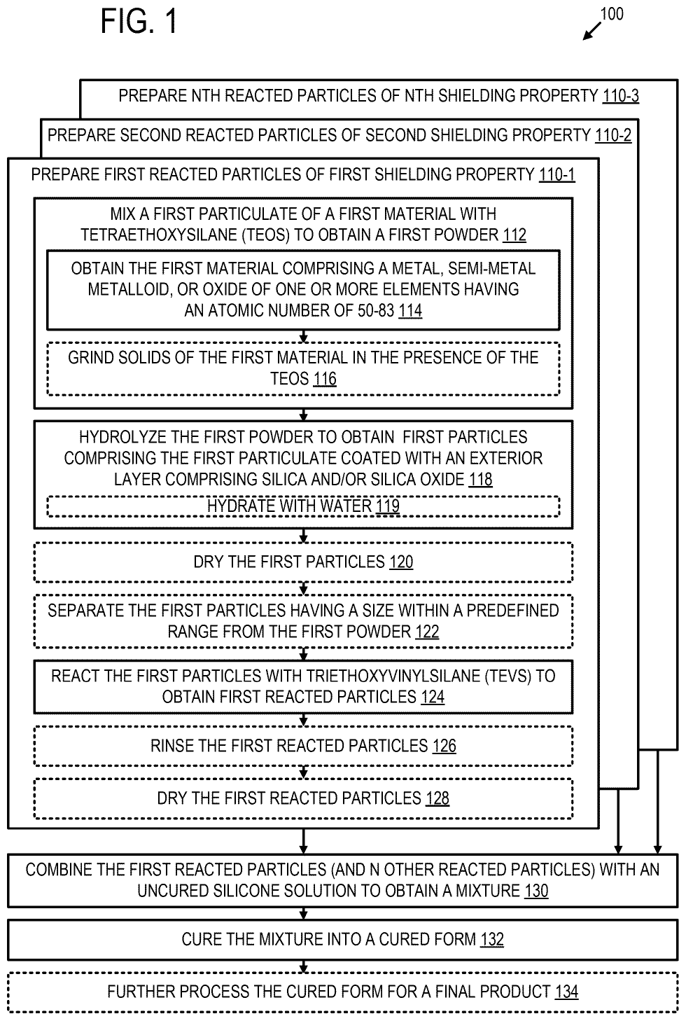

FIG. 1 is a flow diagram depicting an example method 100 of manufacturing an article of ionizing radiation shielding. Method 100 includes the general steps of preparing reacted particles at 110, combining the reacted particles with an uncured silicone solution to obtain a mixture at 130, curing the mixture into a cured form at 132, and depending on implementation, further processing the cured form for a final product at 134.

In at least some examples, two or more sets of reacted particles 110-1, 110-2, etc. through 110-N can be prepared as separate batches, where N represents the number of sets of reacted particles having different ionizing radiation shielding properties. Differences in ionizing radiation shielding properties, such as peak shielding energies can result from differences in the materials from which the reacted particles are obtained. For example, a broader spectral range of ionizing radiation shielding can be obtained by utilizing reacted particles featuring different materials that each provide a different peak shielding energy.

Referring to operation 110-1, the method can include preparing first reacted particles of a first ionizing radiation shielding property. Operations 112-128 can be performed as part of operation 110-1 for the first reacted particles. Additional batches of reacted particles having different ionizing radiation shielding properties can be prepared by performing some or all of operations 112-128 as part of operations 110-2 through 110-N.

As part of operation 110-1, at 112, the method includes mixing a first particulate of a first material with tetraethoxysilane (TEOS) to obtain a first powder. TEOS can be represented by chemical formula Si(OC₂H₅)₄. As an example, the weight ratio of the first particulate of the first material to the TEOS can be within the range of 1:500 to 1:2000, inclusive of these example bounds. While the examples described herein utilize TEOS as part of preparing reacted particles, one or more other suitable alkoxides of silicon can be used individually or in combination (with or without TEOS) to obtain the first powder at operation 112.

The first material, as an example for operation 110-1, comprises a metal, semi-metal, metalloid, or oxide of one or more elements having an atomic number of 50 through 83 that is obtained at 114 as part of operation 112. Examples of elements having an atomic number of 50 through 83 include: Element 50: Sn-Tin; Element 51: Sb-Antimony; Element 52: Te—Tellurium; Element 53: I—Iodine; Element 54: Xe—Xenon; Element 55: Cs—Cesium; Element 56: Ba—Barium; Element 57: La—Lanthanum; Element 58: Ce—Cerium; Element 59: Pr—Praseodymium; Element 60: Nd—Neodymium; Element 61: Pm—Promethium; Element 62: Sm—Samarium; Element 63: Eu—Europium; Element 64: Gd—Gadolinium; Element 65: Tb—Terbium; Element 66: Dy—Dysprosium; Element 67: Ho—Holmium; Element 68: Er—Erbium; Element 69: Tm—Thulium; Element 70: Yb—Ytterbium; Element 71: Lu—Lutetium; Element 72: Hf—Hafnium; Element 73: Ta—Tantalum; Element 74: W—Tungsten; Element 75: Re—Rhenium; Element 76: Os—Osmium; Element 77: Ir—Iridium; Element 78: Pt—Platinum; Element 79: Au—Gold; Element 80: Hg—Mercury; Element 81: Tl—Thallium; Element 82: Pb—Lead; and Element 83: Bi—Bismuth.

As a specific example, the first material can comprise or consist of Bismuth solids. A second material used for operation 110-2 can comprise a second metal, semi-metal, metalloid, or oxide of one or more elements having an atomic number of 50 through 83 that differs from the first material of operation 110-1 (and each other material of operations 110-1 through 110-N). Additional materials, for example, can comprise or consist of solids of tungsten, tin, antimony, barium, hafnium, tantalum, and the lanthanoids and their oxide forms. Similarly, an Nth material used for operation 110-N can comprise an Nth metal, semi-metal, metalloid, or oxide of one or more elements having an atomic number of 50 through 83 that differs from each other material used for operations 110-1 through 110-N. While operations 110-2 through 110-N are depicted and described with reference to method 100, it will be understood that operations 110-2 through 110-N can be omitted where the first material exhibits suitable ionizing radiation shielding properties for a particular implementation.

Depending on the first material used for operation 110-1, mixing the first particulate with the TEOS can include or otherwise be performed by grinding solids of the first material in the presence of the TEOS at 116. Grinding performed at operation 116 can be used to obtain particulate of a particular size and/or shape from solids of an initial size and/or shape. For example, the solids of the first material prior to grinding are initially larger in size than the first particulate. Additionally, grinding performed at 116 can be performed to remove corrosion (e.g., oxidization) that may be present on surfaces of the solids. In at least some examples, grinding solids of the first material or any other material can be performed within a ball mill in the presence of the TEOS and/or other suitable alkoxide(s) of silicon. However, it will be understood that other machines or devices can be used to perform grinding 116 and/or mixing at 112. Furthermore, in at least some examples, such grinding may be omitted, such as where the particulate of the material has a suitable initial shape and where an initial level of surface corrosion is suitable for a particular implementation.

At 118, the method includes hydrolyzing the first powder to obtain first particles comprising the first particulate coated with an exterior layer comprising silica and/or silica oxide. As an example, hydrolyzing the first powder can include hydrating the first powder with water at 119. TEOS and/or other alkoxide(s) of silicon utilized at operation 112 exhibit degradation in the presence of water. Hydrolyzing the first powder at operation 118 can performed to convert the TEOS or other alkoxide(s) of silicon to the exterior layer comprising silica and/or silica oxide.

At 120, the first particles obtained at operation 118 can be dried with or without application of heat to the first particles. Drying performed at operation 120 can provide the benefit of enabling the first particles having a size within a predefined range to be separated at 122 from smaller or larger particles that are present within the first powder following hydrolyzing performed at operation 118. As examples, the predefined range can be 10 to 25 μm, 25 to 100 μm, 50 to 200 μm, or 10 to 200 μm, inclusive of the example bounds. However, it will be understood that operations 120 and 122 may not be performed in at least some examples. Furthermore, drying and/or separating operations can additionally or alternatively performed after obtaining the first powder at operation 112, but prior to hydrolyzing the first powder at operation 118.

At 124, the method includes reacting the first particles with triethoxyvinylsilane (TEVS) to obtain first reacted particles having an exterior functional layer. As an example, the first particles can be mixed with TEVS in liquid form as part of operation 124. TEVS can be represented by chemical formula H₂C=CHSi(OC₂H₅)₃, and can also be referred to as Vinyltriethoxysilane or (Triethoxysilyl)ethylene. As examples, the weight ratio of the first particles to the TEVS can be 1:100, 1:500 or 1:1000, inclusive of the example bounds. While the examples described herein utilize TEVS as part of preparing reacted particles, one or more other suitable silane coupling/adhesion promoting agent(s) may be used individually or in combination (with or without TEVS) to obtain the first reacted particles at operation 124.

In at least some examples, reacting the first particles with the TEVS and/or other silane coupling/adhesion promoting agent(s) may be performed in the presence of water and ammonia or other suitable base solution. The TEVS and/or other silane coupling/adhesion promoting agent(s) are typically added to the particles to be reacted before the water and base solution, in order to obtain thorough dispersion and association with particulate surfaces, prior to hydrolyzation of the silanes.

At 126, the first reacted particles are rinsed, for example, with an alcohol such as ethanol. Alcohol can be used at operation 126 to remove unreacted TEVS and/or other silane coupling/adhesion promoting agent(s), to remove excess silicon particles, and to clean the reacted particles. At 128, the first reacted particles can be dried with or without applying heat to the first reacted particles.

At 130, the first reacted particles obtained from operation 110-1 are combined with an uncured silicone solution to obtain a mixture. Where other reacted particles having different ionizing radiation shielding properties are obtained via operations 110-2 through 110-N, those other reacted particles can also be combined at operation 130 to obtain the mixture. For implementations that seek to provide a consistent magnitude and spectrum of ionizing radiation shielding per linear dimension of material, the mixture obtained at operation 130 would seek to obtain a homogenous spatial distribution of the first reacted particles (and any other reacted particles to be incorporated) throughout the uncured silicone solution prior to curing.

In at least some examples, the uncured silicone solution can take the form of a two-part compound, such as a two-part platinum heat cured rubber (HCR) silicone that features a catalyst component and a silicon cross-linking component. However, it will be understood that other suitable silicone and elastomeric rubber compounds can be used, including room temperature vulcanized silicone, liquid silicones, peroxide cured silicones, platinum cured silicones, tin cured silicones, gum silicones, liquid silicone rubber (LSR), flurosilicone, and other diene rubbers, such as polyisoprene, polybutadiene, and polychloroprene. Mass loading of particles in composites can range from low (10% by weight), to high (95% by weight), inclusive of these example bounds. As an example, a typical material will have 85% by weight inorganic particle filler, and 45-50% particle filler by volume.

At 132, the method includes curing the mixture into a cured form. In at least some examples, the mixture can be cured within a mold, with or without application of heat. For example, heat may be applied where the silicon rubber compound is a heat cured compound. The cured form of the mixture can take the form of a flexible sheet of ionizing radiation shielding, as an example. However, other suitable form factors can be achieved for a given implementation.

At 134, the method can include further processing the cured form for a final product. As examples, the cured form of the mixture can be cut, machined, bent, folded, and/or combined with other components to form the final product. For example, within the context of an ionizing radiation shielding apron, the cured form of the mixture serves as a flexible sheet of ionizing radiation shielding that is combined with an exterior textile, exterior adhesive, or other exterior material that forms a shell of the product.

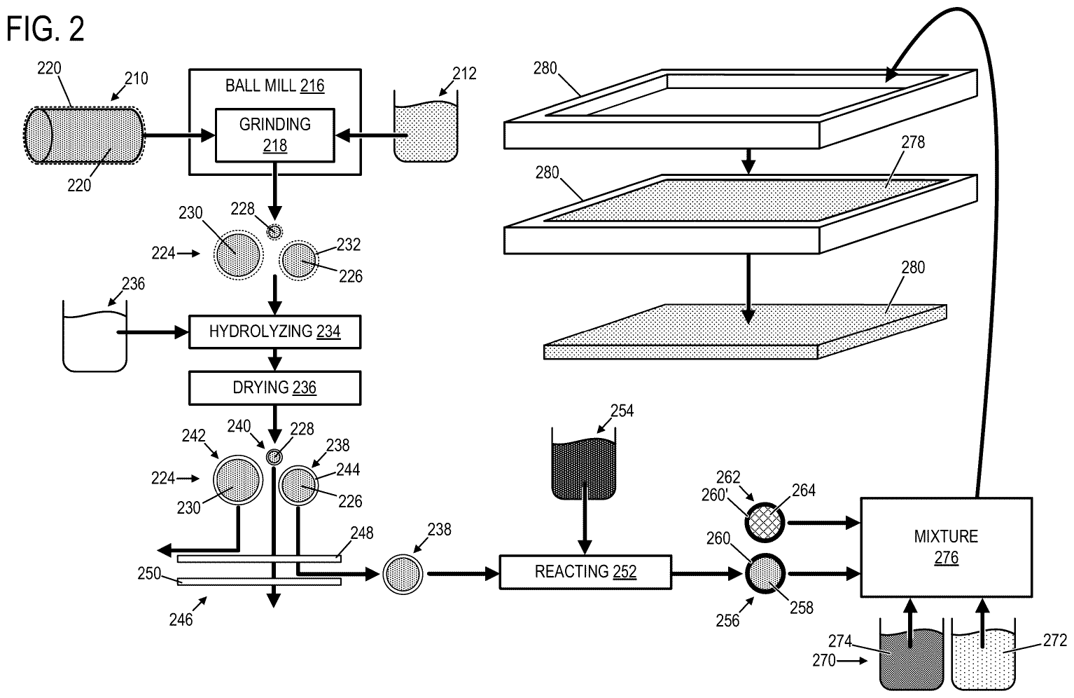

FIG. 2 is a schematic diagram depicting an example implementation of method 100 of FIG. 1. Within the example of FIG. 2, solids of a material 210 and TEOS 212 (and/or other suitable alkoxide(s) of silicon) in liquid form are added to a ball mill 216 where grinding 218 is performed. Material 210, as an example, can comprise a metal, semi-metal, metalloid, or oxide of one or more elements having an atomic number of 50 through 83, as previously described with reference to FIG. 1.

An example instance of a solid form of material 210 is schematically depicted at 220 in FIG. 2 having an initial shape. Also in this example, solids of material 210 includes an outer layer of corrosion represented schematically at 222. For example, material 210 can comprise bismuth initially having an outer layer of corrosion caused by oxidation or other interaction. This outer layer of corrosion can be removed by grinding 218. However, it will be appreciated that solids of other materials processed according to method 100 of FIG. 1 may not have an initial layer of corrosion.

Particulate of material 210 that is generated from grinding 218 is mixed with the TEOS 214 as part of the grinding process to obtain a powder 224. Example particulate is schematically depicted in FIG. 2 at 226, 228, and 230 having a variety of different sizes resulting from grinding 218. This particulate is coated with a layer of TEOS represented schematically at 232 with respect to example particulate 226.

Powder 224 is hydrolyzed at 234, for example, by hydrating with water 236 in liquid form, which causes hydrolysis of the TEOS that coats the particulate of material 210, and the powder is dried at 236. Following hydrolysis performed at 234, powder 224 includes particles comprising the particulate of material 210 coated with an exterior layer comprising silica and/or silicon oxide. Example particles are depicted schematically at 238, 240, and 242 having a variety of different sizes. An example silica and/or silica oxide layer 244 is depicted schematically in FIG. 2 with respect to example particulate 226.

Particles of powder 224 are separated at 246 to obtain a subset of the particles having a size that is within a predefined range. For example, powder 224 is passed through one or more porous screens or sieves 248, 250, etc. to separate particles larger than the predefined range (e.g., 242) and particles smaller than the predefined range (e.g., 240) from particles that are within the predefined range (e.g., 238).

The subset of particles within the predefined range (e.g., 238) are reacted at 252 with TEVS 254 (and/or other suitable silane coupling agent(s)) in liquid form to obtain reacted particles, an example of which is depicted schematically at 256. As previously described with reference to method 100 of FIG. 1, reacting the particles can be performed in the presence of water and ammonia or other base solution. The reacted particles include the particulate of the material 210 depicted schematically at 258 coated with a functional layer 260 formed by the silica and/or silica oxide layer 244 being reacted with TEVS 254. As an example, the exterior functional layer can be comprised of organic or inorganic moieties. Functional layer 260 can improve adhesion between the reacted particles 256 and a silicon rubber compound 270.

In at least some examples, one or more other types of materials can be processed according to method 100 of FIG. 1 to obtain additional reacted particles that can be mixed with reacted particles 256. These other types of materials that differ from material 210 can also comprise a metal, semi-metal, metalloid, or oxide of one or more elements having an atomic number of 50 through 83. Within FIG. 2, additional reacted particles 262 are depicted schematically as being formed by particulate 264 of a different material than material 210 having a functional layer 260′ that can improve adhesion between the reacted particles 262 and the silicon rubber compound 270. In this example, silicon rubber compound 270 in uncured form includes a two-part compound 272, 274 that is mixed to initiate curing.

Reacted particles 256 and any other reacted particles (e.g., 262) to be incorporated into an article of ionizing radiation shielding are mixed with the uncured silicon rubber compound 270 to obtain a mixture 276. In at least some examples, the reacted particles can be rinsed with an alcohol prior to mixing with the uncured silicon rubber compound to clean the particles and improve adhesion.

Mixture 276 is cured into a cured form 278. This cured form 278 may be referred to as a cured composite. As an example, mixture 276 can be cured within a mold 280. However, other suitable techniques including extrusion, rolling, etc. can be used to obtain cured form 278. In the example of FIG. 2, the cured form 278 forms a sheet of ionizing radiation shielding that can optionally be further processed for a final product. However, it will be understood that the mixture 276 can be cured into other suitable forms.

As an example, a cured composite formed by the techniques disclosed herein contains 12% or less by weight silicone. In this example or other examples disclosed herein, a cured composite can contain 80% or greater by weight bismuth. In this example or other examples disclosed herein, a cured composite can contain 80-99.9% by weight particles of a metal, semi-metal, metalloid, or oxide of one or more elements having an atomic number of 50-83 embedded in silicone. In this example or other examples disclosed herein, the particles of a metal, semi-metal, metalloid, or oxide of one or more elements having an atomic number of 50-83 of the cured composite consist of or consist essentially of particles of 25-200 μm, inclusive of the bounds.

According to an example disclosed herein, a method of manufacturing an article of ionizing radiation shielding comprises: mixing a first particulate of a first material with an alkoxide of silicon to obtain a first powder, wherein the first material comprises a metal, semi-metal, metalloid, or oxide of one or more elements having an atomic number of 50 through 83; hydrolyzing the first powder to obtain first particles comprising the first particulate coated with an exterior layer comprising silica; reacting the first particles with a silane coupling agent to obtain first reacted particles; combining the first reacted particles with an uncured silicone solution to obtain a mixture; and curing the mixture into a cured form. In this example or other examples disclosed herein, the alkoxide of silicon comprises tetraethoxysilane (TEOS); and the silane coupling agent comprises triethoxyvinylsilane (TEVS). In this example or other examples disclosed herein, the method further comprises grinding solids of the first material in the presence of the alkoxide of silicon; and the solids of the first material prior to said grinding are initially larger in size than the first particulate. In this example or other examples disclosed herein, the first material comprises bismuth. In this example or other examples disclosed herein, the grinding the solids of the first material includes grinding the solids of the first material in a ball mill in the presence of the alkoxide of silicon. In this example or other examples disclosed herein, the method further comprises: mixing a second particulate of a second material with alkoxide of silicon to obtain a second powder, wherein the second material comprises another metal, semi-metal, metalloid, or oxide of one or more elements having an atomic number of 50 through 83 that differs from the first material; hydrolyzing the second powder to obtain second particles comprising the second particulate coated with an exterior layer comprising silica and/or silica oxide; reacting the first particles with a silane coupling agent to obtain second reacted particles; and combining the second reacted particles with the first reacted particles and the uncured silicone solution to obtain the mixture. In this example or other examples disclosed herein, the first material comprises one or more of tungsten, tin, or antimony; and the second material comprises one or more of tungsten, tin, or antimony in a different mass ratio than the first material. In this example or other examples disclosed herein, hydrolyzing the first powder includes hydrating the first powder with water; and hydrolyzing the second powder includes hydrating the second powder with water. In this example or other examples disclosed herein, the method further comprises: separating the first particles having a size within a predefined range from the first powder. In this example or other examples disclosed herein, the predefined range includes 25-200 μm, inclusive of the bounds. In this example or other examples disclosed herein, hydrolyzing the first powder includes hydrating the first powder with water.

According to another example disclosed herein, an article of ionizing radiation shielding comprises: a cured mixture of silicone and a first set of reacted particles distributed throughout the cured mixture, wherein the first set of reacted particles each include a first material having an exterior functional layer; the first set of reacted particles being prepared prior to curing the cured mixture by: mixing a first particulate of the first material with an alkoxide of silicon to obtain a first powder, wherein the first material comprises a metal, semi-metal, metalloid, or oxide of one or more elements having an atomic number of 50 through 83; hydrolyzing the first powder to obtain first particles comprising the first particulate coated with an exterior layer comprising silica and/or silica oxide; and reacting the first particles with a silane coupling agent to obtain the first set of reacted particles.

According to another example disclosed herein, an article of ionizing radiation shielding comprises: a cured mixture of silicone, a first set of reacted particles, and a second set of reacted particles distributed throughout the cured mixture, wherein the first set of reacted particles each include a first material having an exterior functional layer and the second set of reacted particles each include a second material having an exterior functional layer; the first set of reacted particles being prepared prior to curing the cured mixture by: mixing a first particulate of the first material with an alkoxide of silicon to obtain a first powder, wherein the first material comprises bismuth; hydrolyzing the first powder to obtain first particles comprising the first particulate coated with an exterior layer comprising silica and/or silica oxide; and reacting the first particles with a silane coupling agent to obtain the first set of reacted particles; wherein the first set of reacted particles and the second set of reacted particles consist essentially of particles within a range of 25-200 μm, inclusive of the bounds; and wherein the second material comprises another metal, semi-metal, metalloid, or oxide of one or more elements having an atomic number of 50 through 83 that differs from the first material.

It will be understood that the configurations and/or approaches described herein are exemplary in nature, and that these specific embodiments or examples are not to be considered in a limiting sense, because numerous variations are possible. The specific methods described herein may represent one or more of any number of processing approaches. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of manufacturing an article of ionizing radiation shielding, the method comprising:
mixing a first particulate of a first material with an alkoxide of silicon to obtain a first powder, wherein the first material comprises a metal, semi-metal, metalloid, or oxide of one or more elements having an atomic number of 50 through 83;
hydrolyzing the first powder to obtain first particles comprising the first particulate coated with an exterior layer comprising silica;
reacting the first particles with a silane coupling agent to obtain first reacted particles;
combining the first reacted particles with an uncured silicone solution to obtain a mixture; and
curing the mixture into a cured form.

2. The method of claim 1, wherein the alkoxide of silicon comprises tetraethoxysilane (TEOS); and
wherein the silane coupling agent comprises triethoxyvinylsilane (TEVS).

3. The method of claim 1, wherein the method further comprises grinding solids of the first material in the presence of the alkoxide of silicon;
wherein the solids of the first material prior to said grinding are initially larger in size than the first particulate.

4. The method of claim 3, wherein the first material comprises bismuth.

5. The method of claim 3, wherein the grinding the solids of the first material includes grinding the solids of the first material in a ball mill in the presence of the alkoxide of silicon.

6. The method of claim 1, further comprising:
mixing a second particulate of a second material with alkoxide of silicon to obtain a second powder, wherein the second material comprises another metal, semi-metal, metalloid, or oxide of one or more elements having an atomic number of 50 through 83 that differs from the first material;
hydrolyzing the second powder to obtain second particles comprising the second particulate coated with an exterior layer comprising silica and/or silica oxide;
reacting the first particles with a silane coupling agent to obtain second reacted particles; and
combining the second reacted particles with the first reacted particles and the uncured silicone solution to obtain the mixture.

7. The method of claim 6, wherein the first material comprises one or more of tungsten, tin, or antimony; and
wherein the second material comprises one or more of tungsten, tin, or antimony in a different mass ratio than the first material.

8. The method of claim 6, wherein hydrolyzing the first powder includes hydrating the first powder with water; and
wherein hydrolyzing the second powder includes hydrating the second powder with water.

9. The method of claim 1, further comprising:
separating the first particles having a size within a predefined range from the first powder.

10. The method of claim 9, wherein the predefined range includes 25-200 μm, inclusive of the bounds.

11. The method of claim 1, wherein hydrolyzing the first powder includes hydrating the first powder with water.

12. An article of ionizing radiation shielding, comprising:
a cured mixture of silicone and a first set of reacted particles distributed throughout the cured mixture, wherein the first set of reacted particles each include a first material having an exterior functional layer;
the first set of reacted particles being prepared prior to curing the cured mixture by:
mixing a first particulate of the first material with an alkoxide of silicon to obtain a first powder, wherein the first material comprises a metal, semi-metal, metalloid, or oxide of one or more elements having an atomic number of 50 through 83;
hydrolyzing the first powder to obtain first particles comprising the first particulate coated with an exterior layer comprising silica and/or silica oxide; and
reacting the first particles with a silane coupling agent to obtain the first set of reacted particles.

13. An article of ionizing radiation shielding, comprising:
a cured mixture of silicone, a first set of reacted particles, and a second set of reacted particles distributed throughout the cured mixture, wherein the first set of reacted particles each include a first material having an exterior functional layer and the second set of reacted particles each include a second material having an exterior functional layer;
the first set of reacted particles being prepared prior to curing the cured mixture by:
mixing a first particulate of the first material with an alkoxide of silicon to obtain a first powder, wherein the first material comprises bismuth;
hydrolyzing the first powder to obtain first particles comprising the first particulate coated with an exterior layer comprising silica and/or silica oxide; and
reacting the first particles with a silane coupling agent to obtain the first set of reacted particles;
wherein the first set of reacted particles and the second set of reacted particles consist essentially of particles within a range of 25-200 μm, inclusive of the bounds; and
wherein the second material comprises another metal, semi-metal, metalloid, or oxide of one or more elements having an atomic number of 50 through 83 that differs from the first material.
